(19) United States
(12) Patent Application Publication
(10) Pub. No.: US 2022/0394006 A1
(43) Pub. Date: Dec. 8, 2022

(54) Electronic Message Reply Criteria Tracking and Compensation Initiation System

(71) Applicant: Dylan W. Delancey, Prairie Village, KS (US)

(72) Inventor: Dylan W. Delancey, Prairie Village, KS (US)

(21) Appl. No.: 17/819,919

(22) Filed: Aug. 15, 2022

Related U.S. Application Data
(63) Continuation of application No. 16/842,653, filed on Apr. 7, 2020, now abandoned.
(60) Provisional application No. 62/920,011, filed on Apr. 8, 2019.

(51) Int. Cl. H04L 51/214; H04W 4/12; H04L 51/212; H04L 51/234

(52) U.S. Cl. CPC H04L 51/214; H04W 4/12; H04L 51/212; H04L 51/234

(57) ABSTRACT

Systems and methods for incentivizing responses to messages via compensation. A method comprises using machine readable instructions to: (a) receive a receiving message; (b) identify in a system database a compensation message that: (i) has a reply compensation deadline time that is greater than or equal to a receiving message time; and (ii) a recipient of said receiving message is the same as a sender of said compensation message; (c) adjust a compensation amount based on a difference between said reply compensation deadline time and said receiving message time; and (d) trigger a compensation to a recipient of said compensation message.

### CROSS-REFERENCE TO RELATED APPLICATIONS

The present application is a continuation-in-part of application Ser. No. 16/842,653 filed Apr. 7, 2020 and titled ELECTRONIC MESSAGE REPLY CRITERIA TRACKING AND COMPENSATION INITIATION SYSTEM, which claims priority to U.S. Provisional Patent Application No. 62/920,011, filed Apr. 8, 2019, and entitled ELECTRONIC MESSAGE REPLY CRITERIA TRACKING AND COMPENSATION INITIATION SYSTEM. The entire disclosure of these applications is hereby incorporated by reference herein in their entirety.

### FIELD OF THE DISCLOSURE

The field of the disclosure relates generally to message systems and, more particularly, to methods and systems for compensating a message recipient for replying to a message.

### BACKGROUND OF THE DISCLOSURE

Message systems, such as SMS messages and the like, enable users to conveniently send brief messages to other users without the need to call the user or otherwise speak to the user. Recipients of such messages, however, may be inclined to simply read the message and not reply, or simply ignore the message altogether. Known message systems do not enable a sender to incentivize and otherwise induce a recipient to read and respond to a message. As a result, there is a need for a message system that provides a mechanism for a send to induce a reply message from a recipient.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a server is provided. The server includes a database including a message table having a plurality of message records, and a processor with computer executable instructions in communication with the database. The processor with computer executable instructions is programmed to receive, from a sender via a remote computing device, input data associated with a compensation message. The input data includes a reply compensation value, a reply deadline, a recipient, and message content. The processor with computer executable instructions is also programmed to generate the compensation message based on the input data and transmit the compensation message to the recipient. Furthermore, the processor with computer executable instructions is programmed to receive a reply message from the recipient. The reply message is associated with the compensation message. Moreover, the processor with computer executable instructions is programmed to determine that the reply message was received before, after, or equal to the reply deadline and determine a total compensation amount owed associated with the reply message based on the reply compensation value, reply deadline, and the time of the recipient's reply message.

In another aspect, a method is provided. The method includes receiving, from a sender via a remote computing device, input data associated with a compensation message. The input data includes a reply compensation value, a reply deadline, a recipient, and message content. The method also includes generating the compensation message based on the input data and transmitting the compensation message to the recipient. Furthermore, the method includes receiving a reply message from the recipient. The reply message is associated with the compensation message. Moreover, the method includes determining that the reply message was received before, after, or equal to the reply deadline and determining a total compensation amount owed associated with the reply message based on the reply compensation value, reply deadline, and the time of the recipient's reply message.

In another aspect, one or more non-transitory computer-readable storage media having computer executable instructions embodied thereon is provided. When executed by at least one processor, the computer executable instructions cause the processor to receive, from a sender via a remote computing device, input data associated with a compensation message. The input data included a reply compensation value, a reply deadline, a recipient, and message content. The computer executable instructions also cause the processor to generate the compensation message based on the input data and transmit the compensation message to the recipient. Furthermore, the computer executable instructions cause the processor to receive a reply message from the recipient, the reply message associated with the compensation message. Moreover, the computer executable instructions cause the processor to determine that the reply message was received before, after, or equal to the reply deadline and determine the total compensation amount owed associated with the reply message based on the reply compensation value, reply deadline, and the time of the recipient's reply message.

In an aspect, a method comprises using machine readable instructions to: (a) receive a receiving message; (b) identify in a system database a compensation message that: (i) has a reply compensation deadline time that is greater than or equal to a receiving message time; and (ii) a recipient of said receiving message is the same as a sender of said compensation message; (c) adjust a compensation amount based on a difference between said reply compensation deadline time and said receiving message time; and (d) trigger a compensation to a recipient of said compensation message.

In another embodiment, a method comprises using machine readable instructions to: (a) receive a receiving message; and (b) identify in a system database a compensation message that: (i) has a reply compensation deadline time that is greater than or equal to a receiving message time; and (ii) a recipient of said receiving message is the same as a sender of said compensation message.

In yet another aspect, a method, comprises using machine readable instructions to receive messages each having a reply deadline and a deadline amount value.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example electronic message reply compensation system including a messaging service system, in accordance with one embodiment of the present disclosure;

FIG. 2 is an example configuration of a message server of the messaging service system shown in FIG. 1;

FIG. 3 is an example configuration of a client system for use in the electronic message reply compensation system shown in FIG. 1;

FIG. 4 is an example configuration of a server system for use in the electronic message reply compensation system shown in FIG. 1;

FIG. 5 is an example schematic illustration of a database comprising a message table including a compensation message record;

FIG. 6 is an example schematic illustration of the message table shown in FIG. 5, including a compensation message record and a reply message record;

FIG. 7 is a flowchart illustrating an example of a computer-implemented method for determining a total compensation amount owed to a message recipient for replying to a compensation message, in accordance with one embodiment of the present disclosure;

FIG. 8 is an example flowchart illustrating the details of operation of the method shown in FIG. 7; and

FIG. 9 is an example flowchart illustrating the details of operation of the method shown in FIG. 7.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes a body of data, a relational database management system (RDBMS), a nonrelational database system and/or other database system. As used herein, database includes, and without limitation, a collection of data, including one or more database types, for example, hierarchical database, relational database, flat file database, object-relational database, object oriented database, network database, centralized database, cloud database, commercial database, distributed database, end-user database, graph database, NoSQL database, open-source database, operational database, personal database, decentralized database, blockchain database, and any other structured and/or unstructured collection of data that is stored. Examples of RDBMS's include, for example, and without limitation, Amazon® Relational Database Service (Amazon® is a registered trademark of Amazon.com Inc, of Seattle, Wash.), Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database or collection of databases may be used that enable the systems and methods to operate as outlined herein. As used herein, the term “server” includes, without limitation, one or more computing machines, one or more computing systems, computer, server, server system, computer network, virtual machine, virtual server, virtual network, Erlang Open Telecom Platform, Erlang Runtime System, Google® Cloud Platform (Google® is a registered trademark of Google Inc, of Mountainview, Calif.), AWS® (AWS® is a registered trademark of Amazon.com Inc, of Seattle, Wash.), IBM® Cloud (IBM® is a registered trademark of International Business Machines Corporation, of Armonk, N.Y.), and/or network.

### Network System

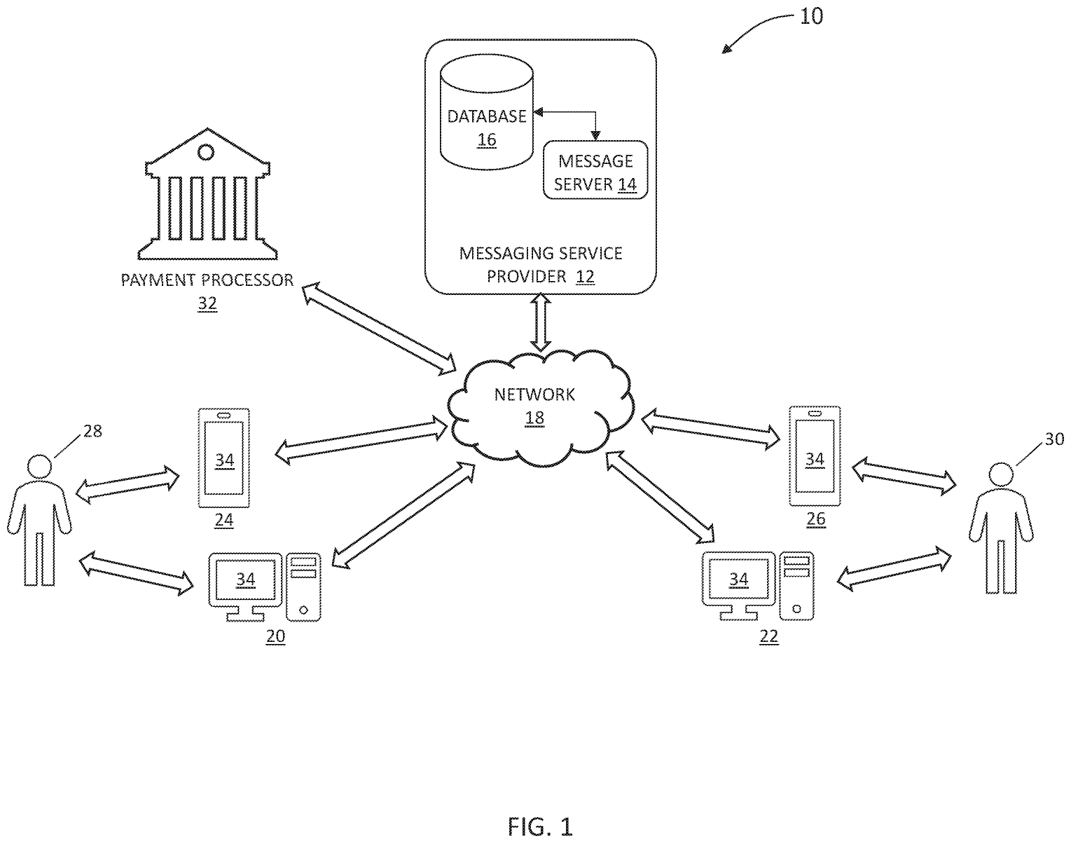

FIG. 1 is a block diagram of an example electronic message reply compensation system 10, in accordance with one embodiment of the present disclosure. The electronic message reply compensation system 10 includes a messaging service system 12 having a message server 14 coupled to a database 16. In addition, the electronic message reply compensation system 10 includes a plurality of user devices, such as computing devices 20, 22 and/or mobile computing devices 24, 26. A plurality of users, such as users 28 and 30, interact with one or more of the computing devices 20, 22 and/or mobile computing devices 24, 26 to transmit/receive electronic messages to/from other users via the messaging service system 12. To transmit/receive electronic messages via the messaging service system 12, the computing devices 20, 22 and/or mobile computing devices 24, 26 are coupled in communication with the messaging service system 12, and more particularly, with the message server 14, via a communications network 18. Furthermore, the electronic message reply compensation system 10 may include a third-party payment processor 32 configured to processes payments among the users 28, 30 and the messaging service system 12. Although parts of the electronic message reply compensation system 10 are presented in one way, other embodiments of the electronic message reply system may include the same or different parts arranged otherwise, and/or the processes of the system divided up amongst the same or different parts arranged otherwise, for example, alternative ways of dividing the processes amongst the parts of the system, sourcing and processing of the computer executable instructions, ways the message data is created and processed, routing of messages and communications, methods and apparatuses used to accomplish the system processes, forms of payments to be anything of value (e.g., fiat money, cryptocurrency, NFT(s), virtual money associated with a computing environment (e.g., a video game), tokens, credits, right(s) in the real and/or the virtual world, good(s), et cetera), and communication between computing devices, etc.

In the example embodiment, the communications network 18 includes, for example, and without limitation, one or more of a local area network (LAN), a wide area network (WAN) (e.g., the Internet, etc.), a mobile network, a virtual network, an intranet and/or any other suitable public and/or private network capable of facilitating communication among the computing devices 20, 22, the mobile computing devices 24, 26, and/or the messaging service system 12. In some embodiments, the network 18 includes more than one type of network, such as a private transaction network provided between the messaging service system 12 and the payment processor 32, and separately, the public Internet, which may facilitate communication between the computing devices 20, 22 and/or mobile computing devices 24, 26 and the messaging service system 12.

With continued reference to FIG. 1, in the exemplary embodiment, each of the computing devices 20, 22 and/or mobile computing devices 24, 26 (e.g., a smartphone or other computing device used by the users 28, 30) includes a user interface 34 that facilitates user interaction with the respective computing device. For example, and without limitation, the user interface 34 enables the users 28, 30 to input information to the computing device 20, 22, 24, or 26, and the computing device can output information to the users 28, 30 (e.g., on a display of the computing device). The user interface 34 enables interaction with the server system, for example, and without limitation, computer executable instructions that communicate with the system, a network application, and/or a messaging application that is installed on the computing devices 20, 22, 24, and 26. In the exemplary embodiment, the messaging application is associated with the messaging service system 12. It is contemplated that fewer or more software applications may be installed on the computing devices 20, 22, 24, and 26 and displayed by the associated user interface 34.

In the exemplary embodiment, the computing devices 20, 22, 24, and 26 communicate with the messaging service system 12, for example, via the network 18, to transmit and/or receive electronic messages to one or more other users (e.g., users 28 and 30) that are participants of a messaging service offered by the messaging service system 12. The computing devices 20, 22, 24, and 26 can be any computing device capable of interconnecting to the network 18, such as the Internet, including a desktop computer, laptop, tablet, mobile web-based device, smartphone, PDA, or other web-based connectable equipment. The computing devices 20, 22, 24, and 26 are interconnected to a network, for example, and without limitation, the Internet, through one or more interfaces including a network, such as a local area network (LAN), a wide area network (WAN), intranet, dial-in-connections, cable modems, wireless modems, special high-speed ISDN lines, Global System for Mobile communications (GSM), 3G, 4G, and 5G mobile communications, and/or other networks.

The messaging service system 12 includes, for example, and without limitation, a computer, a server, a network of multiple computing devices, a virtual server, virtual machine, virtual network, virtual computing device, or the like. The messaging service system 12 includes, for example, and without limitation, an application, a downloadable software application, a web application, an application programming interface (API) server, computer, server, network, virtual machine, virtual server, virtual network, and/or a memory device enabling the computing devices 20, 22 and/or mobile computing devices 24, 26 to be in communication with the messaging service system 12 using, for example, and without limitation, the Internet, an intranet, and/or any other network. As described above, the computing devices 20, 22 and/or mobile computing devices 24, 26 are interconnected via a network, for example, and without limitation, to the Internet through one or more interfaces including a network, as detailed above.

Furthermore, as discussed above, the messaging service system 12 includes, for example, and without limitation, the message server 14, which is connected to the database 16. In one embodiment, the database 16 is stored on the message server 14. In an alternative embodiment, the database 16 may be stored remotely from the message server 14 and may be non-centralized. The database 16 is configured to receive and store system data, for example, and without limitation, user account information, message data, rules and monetary values associated with those accounts, and/or message entries.

In the exemplary embodiment, a user, such as the user 28 (the “sender”), participates in the message service by recording or processing an electronic message, and selecting one or more recipients. The message may come in any form of communication. And the communications and message may be split into parts that are collectively used as part of the communications system. A user may be a person, a computer, a virtual computer, virtual machine, virtual network, machine, or other entity capable of facilitating an action. In the exemplary embodiment, the user initiates a compensation message to an intended recipient, that contains data, namely a reply compensation value, reply deadline, and message content, to be associated with the recorded message. The message does not need to be recorded, so long as it effectively communicates and processes the data accordingly. In another embodiment, the compensation message may contain only a reply compensation value and an intended recipient. And still another embodiment may contain a compensation message comprising of a varied payment condition based on the time of the reply, for example, a compensation message may include, without limitation, a reply compensation value that adjusts between the time a user initiates the compensation message and the time associated with the recipient replying to the compensation message, and information about how the reply compensation would be calculated. The messaging service system 12 may notify each user selected to receive the recorded message (the “recipients”), using a communications network, such as the Internet, an intranet and/or other network, as detailed above. The notification may include part or all of the compensation message data. And the message to the recipient may include for example, and without limitation, sender data, message compensation data, and/or a notice that they received a message. For example, without limitation, each recipient may be notified via email, SMS, text, a web application, messaging application that is installed on their computing device 20, 22, 24, or 26, or any other communications system. In the exemplary embodiment, the recipient opens a messaging application and is provided data regarding the compensation message, namely, the message content, the reply compensation value, and the reply deadline associated with the compensation message. If the recipient selects to reply to the message, the messaging service system 12 records the reply message and the time of the reply. Based on the time of the reply and the reply compensation value, the messaging service system 12 determines a total reply compensation amount owed to the recipient and makes available payment transaction data to the payment processor 32 to process the transaction accordingly. The reply time used can include the time the server records the reply, the time the user initiates the reply message, and/or any time related to the time a recipient replies to the sending user.

### Exemplary Computer Systems

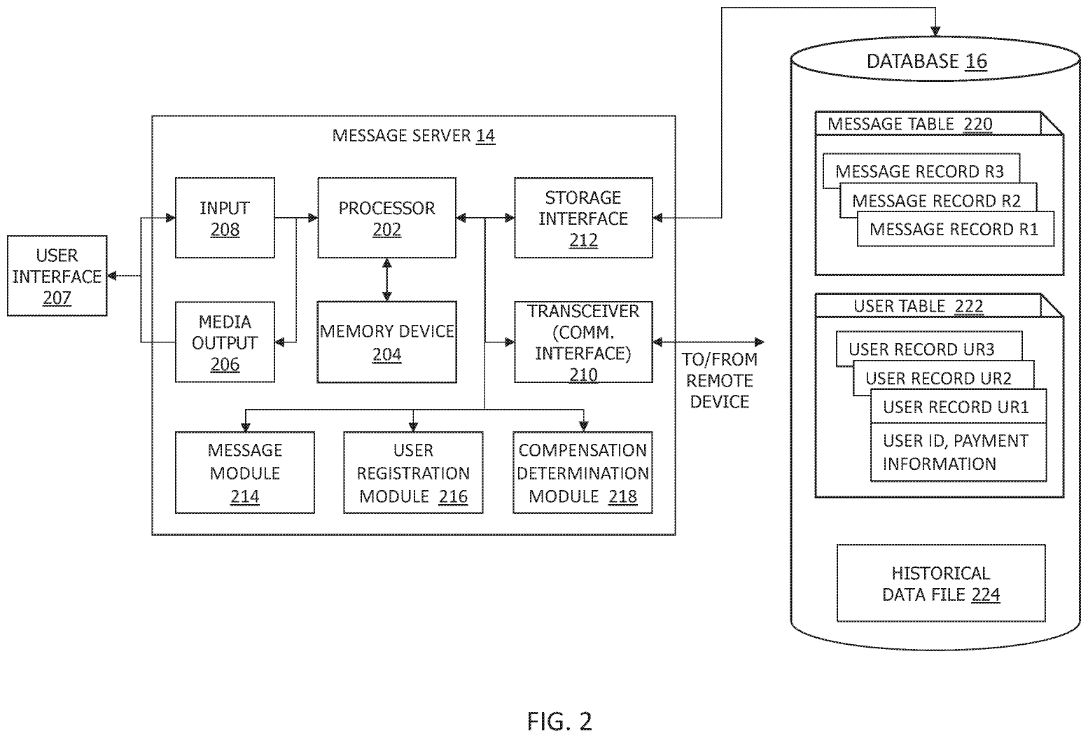

FIG. 2 is an example configuration of the message server 14, which is part of the messaging service system 12 (shown in FIG. 1), in accordance with one aspect of the present disclosure. In the exemplary embodiment, the message server 14 is a computing device configured to connect to one or more of the comput013691ing devices 20, 22, the mobile computing devices 24, 26, and/or any other computing devices, such as computing devices (not shown) of the payment processor 32 (shown in FIG. 1), via the network 18.

In the example embodiment, the message server 14 includes one or more processors 202 for executing instructions. In some embodiments, the computer executable instructions are stored in a memory device 204. The processor 202 includes, for example, and without limitation, one or more processing units arranged, for example, in a multi-core configuration for executing the instructions. The instructions may be executed within a variety of different operating systems on the message server 14, such as UNIX®, Microsoft Windows®, CentOS®, Community Enterprise Operating System®, Linux®, Amazon® Elastic Compute Cloud®, Amazon® EC2®, IBM® Z® mainframes, IBM® z/OS®, Linux®, IBM® z/VM®, IBM® z/VSE® and IBM® z/TPF Fire®, macOS®, iOS®, Android, Fire OS®, Android®, Android TV®, tvOS®, Web, Windows®, UWP®, and VR, etc. More specifically, the instructions may cause various data manipulations on data stored in database 16 (e.g., create, write, read, edit, save, sort, find, compute, update, and delete procedures). It should also be appreciated that upon initiation of a computer-based method, various instructions may be executed during initialization and some computer executable instructions may come from one or more different sources used to instruct one or more parts of the system. Some operations may be required to perform one or more processes described herein, while other operations may be more general and/or specific to a programming language (e.g., Erlang, Elixir, programming languages on top of the BEAM, bytecode, OCaml, Perl, Swift, PHP, Python, BASIC, Kotlin, Go, Golang, JavaScript, Objective-C, Ruby, Flutter® (Flutter® is a registered trademark of Google Inc, of Mountainview, Calif.) React Native® (React Native ° is a registered trademark of Meta Platforms Inc, of Menlo Park, Calif.), C, C#, C++, Java, or other capable programming languages, etc.). The memory device 204 is any device allowing information such as the executable instructions, data, computer executable instructions, and/or written works to be stored and retrieved. The memory device 204 includes one or more computer readable media. In the exemplary embodiment, the processor 202 is operable to execute the executable instructions, contained in program instructions, operations, and/or steps described herein, so as to control the message server 14 to provide desired functionality. In another embodiment, the processor may be computer executable instructions powered by a computer processor, and/or computer executable instructions working with the computer processor.

The message server 14 also may include at least one media output component 206 for presenting information to a user, such as a server administrator (not shown). The media output component 206 is any component capable of conveying information to the user. In some embodiments, the media output component 206 includes an output adapter such as a video adapter and/or an audio adapter. An output adapter is operatively coupled to the processor 202 and operatively connectable to an output device, including for example, and without limitation, a display device, a liquid crystal display (LCD), light emitting diode (LED) display, organic light emitting diode (OLED) display, “electronic ink” display, etc. and/or an audio output device, such as a speaker, or headphones.

In certain embodiments, the message server 14 includes an input device 208 for receiving input from the user. The input device 208 includes, for example, and without limitation, a touch sensitive panel, a touch pad, a touch screen, a stylus, a keyboard, a pointing device, a mouse, and/or an audio input device. A single component such as a touch screen may function as both an output device of the media output component 206 and the input device 208.

The message server 14 also includes a transceiver 210 (broadly, a communication interface), which is communicatively connectable to one or more remote devices such as the computing devices 20, 22, the mobile computing devices 24, 26, and/or any other computing devices via, for example, the network 18 (shown in FIG. 1). The transceiver 210 includes, for example, and without limitation, a wired or wireless network adapter and/or a wireless data transceiver for use with radio frequency communication, near field communication (NFC), and/or with a mobile phone network, Global System for Mobile communications (GSM), 3G, 4G, 5G, or other mobile data network, and/or Worldwide Interoperability for Microwave Access (WiMax) and/or any other communications network and the like. The transceiver 210 includes, for example, and without limitation, numerous communication ports (not shown) to enable the message server 14 to communicate simultaneously with a number of other computers and other devices, including communications as required to simultaneously handle numerous transactions.

Stored in the memory device 204 are, for example, and without limitation, computer readable instructions for providing a user interface 207 to the user via the media output component 206 and, optionally, receiving and processing input from the input device 208. The user interface 207 may include, among other possibilities, a web browser and various software applications. Web browsers enable users to display and interact with media and other information typically embedded on a web page or a website via the Internet and/or other networks. The various software applications allow the user to interact with the message server 14 to further communicate with the computing devices 20, 22, the mobile computing devices 24, 26, etc. to facilitate providing various services to the users 28, 30 (shown in FIG. 1).

The memory device 204 includes, for example, and without limitation, random access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM) and/or other memory systems able to perform the task. The above memory types are exemplary only and are thus not limiting as to the types of memory usable for storage of a computer program.

The database 16 includes, for example, and without limitation, any computer-operated hardware suitable for storing and/or retrieving data. In certain embodiments, the database 16 is integrated into the message server 14. The message server 14 includes, for example, and without limitation, one or more hard disk drives that function as the database 16. In other embodiments, the database 16 is external to the message server 14 and may be accessed, for example, by one or more database servers. For example, the database 16 includes multiple storage units such as hard disks or solid-state disks in a redundant array of inexpensive disks (RAID) configuration. The database 16 includes, for example, and without limitation, a storage area network (SAN) and/or a network attached storage (NAS) system.

In some embodiments, the processor 202 is operatively coupled to the database 16 via a storage interface 212. The storage interface 212 is any component capable of providing the processor 402 with access to the database 16. The storage interface 212 includes, for example, and without limitation, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the database 16.

In certain embodiments, it is contemplated that the message server 14 is implemented as a software application, virtual machine, virtual server and/or virtual network. In such embodiments, the hardware described above, such as the processor 202, the memory device 204, the transceiver 210, and/or the storage interface 212 may be shared with the hardware components of another database server (not shown).

The message server 14 may also include a message module 214, that is configured to monitor the network connections with the computing devices 20, 22 and the mobile computing devices 24, 26, for example, via the transceiver 210, to identify message exchanges and compensation message requests received from users, such as the users 28, 30. The message module 214 is used to write records corresponding to the messages and compensation message requests to the database, for example, and without limitation to one or more tables stored on the database 16, such as a message table 220. In the example, each message is associated with a message record. In one suitable embodiment, the message table 220 includes, for example, a plurality of rows or records, such as message records R₁, R₂, R₃. Each of the message records R₁, R₂, R₃ is associated with a respective user identifier (ID) and includes, for example, a plurality of data fields (e.g., columns of the table), as described further herein. The data fields include, for example, and without limitation, at least a field for the user ID, unique message ID, time of the message request, and the option to include a message text and/or message data file pointer. It is noted that the message records and/or data fields of the message records (e.g., columns of the table) can be stored in one or more databases and/or database tables, and can span one or more databases and/or database tables, and the like. For example, in one embodiment, the data fields associated with the message records may be split into two or more databases and/or database tables, and the message records may be written to different databases, and/or database tables.

A registration module 216 may be configured to communicate with the computing devices 20, 22 and/or mobile computing devices 24, 26 to receive user information from the user 28, 30 during a registration process. The registration module 216 writes the received user information to one or more tables stored on the database 16, such as a user table 222. In one suitable embodiment, the user table 222 includes, for example, a plurality of rows or records, such as user records UR₁, UR₂, UR₃. Each of the user records UR₁, UR₂, UR₃ is associated with a respective user identifier (ID) and includes, for example, a plurality of data fields (e.g., columns of the table). The data fields include, for example, and without limitation, at least a field for the user ID, user payment information (e.g., payment token), payment sender identification, payment receiver identification, and total compensation amount owed, minus any service fees.

The message server 14 may also include a compensation determination module 218 configured to determine a compensation amount owed to a user, such as the user 30 (the “recipient”) for replying to a compensation message. As described above, a user, such as the user 28 (the “sender”), may transmit a compensation message to the recipient. The compensation message is associated with a reply compensation value and reply deadline. As described further herein, the reply compensation value can be a fixed value, payable in full to a user that replies to the compensation message at any time before and/or equal to the reply deadline, or a variable value that changes as the reply deadline approaches.

In addition, the compensation determination module 218 may function as a transaction processing application for executing tokens of value, currencies, cryptocurrencies, points, ratings, NFT, credits, and/or any other payment transactions to the recipient. The transaction processing application may receive payment device details from the sender, for example, from the user table 222 or via his or her computing devices 20, 22, 24, or 26, for compensating the recipient for replying to his or her compensation message. For example, in one embodiment, the transaction processing application may read payment card account details from the user table 222 or the user's digital wallet stored on the computing device 20, 22, 24, or 26, and transmit payment transaction data to the payment processor 32 to process a transaction between the sender and the recipient, for example, by generating one or more payment authorization requests that are routed to an appropriate payment system (not shown).

In the exemplary embodiment, the compensation determination module 218 is configured to provide the payment transaction data to the payment processor 32 upon receipt of a reply message to which compensation is owed, and may include a required authorization and acceptance from the message sender and/or the service provider. Alternatively, the payment transaction data may be provided to the payment processor 32 at predetermined and/or random intervals, such as one (1) second, one (1) minute, five (5) minutes, sixty (60) minutes, daily (once per twenty-four (24) hours), etc. In an example embodiment, the total compensation amount owed may be written to memory device 204, for example, is a user accessible portion, so that a user can quickly analyze the transaction data, such as determining the total compensation amount owed per user, total number of transactions between users, etc. Alternatively, or in addition, the compensation determination module 218 may be configured to write the payment transaction data to a historical data file 224.

In the exemplary embodiment, the database 16 and/or memory device 204 stores one or more programs for controlling the processor 202. The programs include program instructions, operation, and/or steps (which may be referred to as computer-readable instructions) that contain executable operations of the message server 14. When the processor 202 executes the computer-readable instructions, it causes the message server 14 to function as described herein.

The programs may include, for example, one or more conventional operating systems with machine executable instruction (not shown) that control the processor 202 so as to manage and coordinate activities and sharing of resources in the wallet message server 14, and to serve as a host for application programs that run on the message server 14. The one or more conventional operating systems include, for example, and without limitation, UNIX®, Microsoft Windows®, CentOS®, Community Enterprise Operating System®, Linux®, Amazon® Elastic Compute Cloud®, Amazon® EC2®, IBM® Z° mainframes, IBM® z/OS®, Linux®, IBM® z/VM®, IBM® z/VSE® and IBM® z/TPF®, Fire macOS®, iOS®, Android, Fire OS®, Android®, Android TV tvOS®, Web, Windows®, UWP®, and VR, etc. More specifically, the computer readable instructions may cause various data manipulations on data stored in the database 16 (e.g., create, write, read, edit, save, sort, find, compute, update, and delete procedures). It should also be appreciated that upon initiation of a computer-based method, various computer-readable instructions may be executed during initialization. Some operations may be required to perform one or more processes described herein, while other operations may be more general and/or specific to a programming language (e.g., Erlang, Elixir, programming languages on top of the BEAM, bytecode, OCaml, Perl, Swift, PHP, Python, BASIC, Kotlin, Go, Golang, JavaScript, Objective-C, Ruby, Flutter® (Flutter® is a registered trademark of Google Inc, of Mountainview, Calif.) React Native® (React Native ° is a registered trademark of Meta Platforms Inc, of Menlo Park, Calif.), C, C#, C++, Java, or other capable programming languages, etc.).

The database 16 and/or memory device 204 may include, for example, a user registration application (not shown) that, when executed by the processor 202, enables the message server 14 to handle requests from users, such as the users 28, 30 (shown in FIG. 1), to register for messaging services provided by the message server 14. Using the user registration application, the user 24 may create his or her messaging account. The messaging account operates to allow the users 28, 30 to participate in the messaging services offered by the messaging service system 12 and operated by the message server 14.

The user 28, 30 may register for a messaging account with the messaging service system 12 by interacting with a webpage that is hosted by the messaging service system 12. After the user 28, 30 has established his or her account via the webpage, he or she may add payment details for sending/receiving payments for interacting with the messaging service system 12. For example, the user 28, 30 may add one or more of his or her payment cards and/or accounts to his or her messaging account. In one suitable embodiment, the user 28, 30 authorizes the messaging service system 12 work with the payment processor 32 to contact card issuers of the payment card accounts to initiate a process of inputting the relevant payment account data into a digital wallet stored with the user's messaging account.

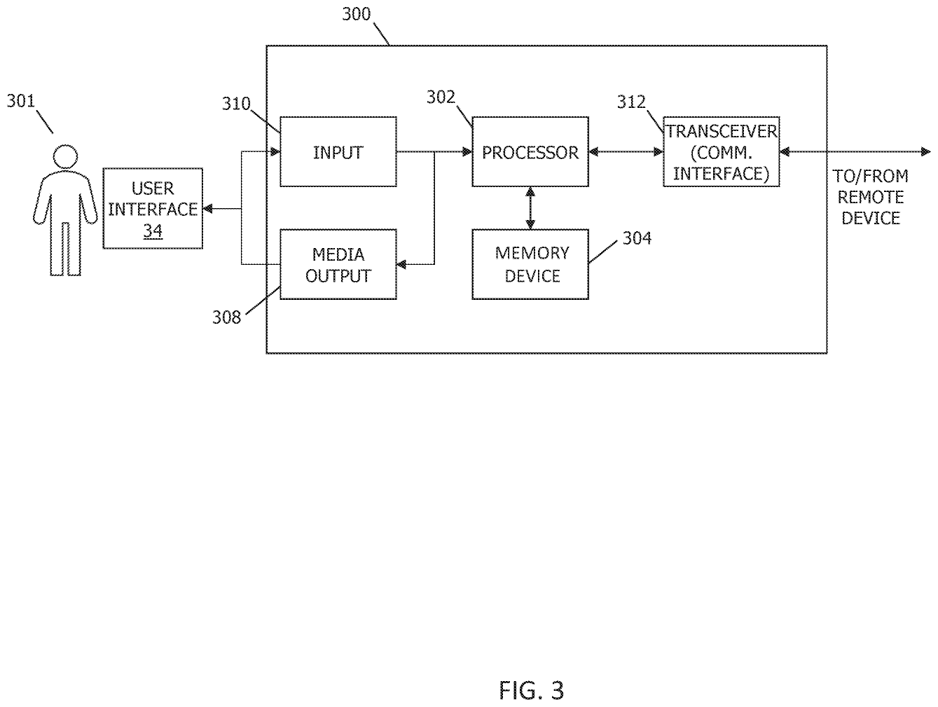

FIG. 3 is an example configuration of a client system 300 operated by a user 301. In some embodiments, the client system 300 may be a user computing device 20, 22, 24, or 26 (each shown in FIG. 1). In addition, the user 301 may be the user 28 or 30 (shown in FIG. 1). In the example embodiment, the client system 300 may include one or more processors 302 for executing instructions. In some embodiments, executable instructions may be stored in a memory device 304. The processor 302 includes, for example, one or more processing units arranged, for example, in a multi-core configuration. The memory device 304 may be any device allowing information such as executable instructions, data, and/or written works to be stored and retrieved. The memory device 304 may include one or more computer readable media.

The client system 300 may also include at least one media output component 308 for presenting information to the user 301. The media output component 308 may be any component capable of conveying information to the user 301. In some embodiments, the media output component 308 may include an output adapter such as a video adapter and/or an audio adapter. An output adapter may be operatively coupled to the processor 302 and may be operatively connectable to an output device such as a display device, a liquid crystal display (LCD), organic light emitting diode (OLED) display, and/or “electronic ink” display, or an audio output device, a speaker, or headphones.

In some embodiments, the client system 300 may include an input device 310 for receiving input from the user 301. The input device 310 may include, for example, touch sensitive panel, touch pad, touch screen, stylus, photographic element and/or camera, optical sensor, gyroscope, accelerometer, position detector, keyboard, pointing device, mouse, and/or audio input device. A single component such as a touch screen may function as both an output device of the media output component 308 and the input device 310. The client system 300 may also include a transceiver 312 (broadly, a communication interface), which is communicatively connectable to a remote device such as the message server 14 (shown in FIG. 1). The transceiver 312 includes, for example, a wired or wireless network adapter or a wireless data transceiver for use with radio frequency communication, near field communication (NFC), and/or with a mobile phone network, Global System for Mobile communications (GSM), 3G, 4G, 5G, or other mobile data network, and/or Worldwide Interoperability for Microwave Access (WiMax) and the like.

Stored in the memory device 304 may be, for example, computer readable instructions for providing the user interface 34 to the user 301 via the media output component 308 and, optionally, receiving and processing input from the input device 310. The user interface 34 may include, among other possibilities, a web browser and various software applications. Web browsers may enable users to display and interact with media and other information typically embedded on a web page or a website. The various software applications may allow the user 301 to interact with the client system 300 to further communicate with the message server 14, other user mobile devices, other computing systems, payment systems, etc. to facilitate transmitting and/or receiving compensation messages and reply messages provided by the messaging service system 12, and optionally, execute a transaction upon delivery of such services.

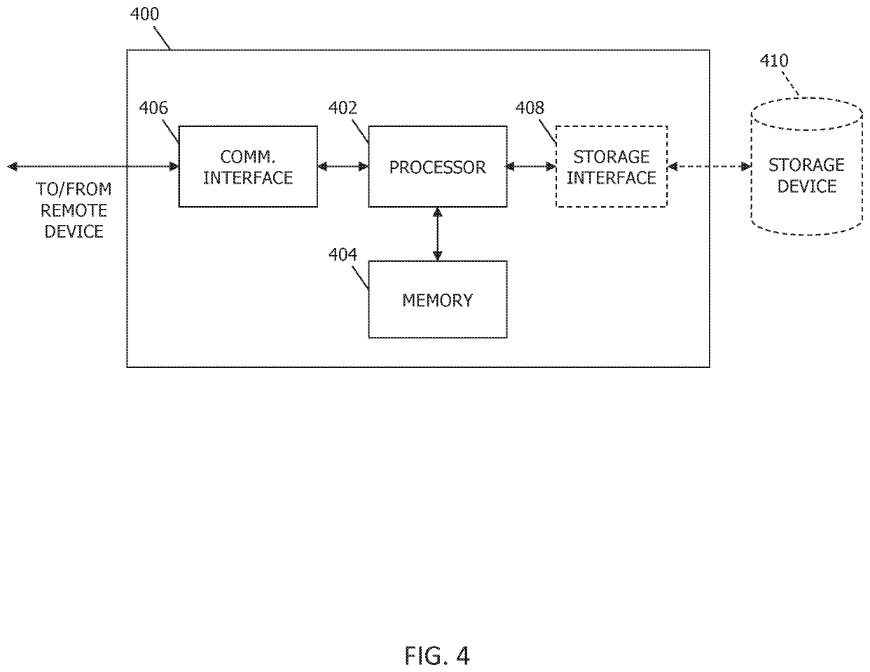

FIG. 4 is an example configuration of a server system 400, such as the messaging service system 12 (shown in FIG. 1). In the example embodiment, the server system 400 may include a processor 402 for executing instructions. The instructions may be stored anywhere, including any part of the system, outside the system, and/or in memory area 404, for example. The processor 402 may include one or more processing units (e.g., in a multi-core configuration) for executing the instructions. The instructions may be executed within a variety of different operating systems on the server system 400, such as UNIX®, Microsoft Windows®, CentOS®, Community Enterprise Operating System®, Linux®, Amazon® Elastic Compute Cloud Amazon® EC2®, IBM® Z° mainframes, IBM® z/OS®, Linux®, IBM® z/VM®, IBM® z/VSE® and IBM® z/TPF®, Fire®, macOS®, iOS®, Android, Fire OS®, Android®, Android TV®, tvOS®, Web, Windows®, UWP®, and VR, etc. More specifically, the instructions may cause various data manipulations on data stored in a storage device 410 (e.g., create, write, read, edit, save, sort, find, compute, update, and delete procedures). It should also be appreciated that upon initiation of a computer-based method, various instructions may be executed during initialization. Some operations may be required to perform one or more processes described herein, while other operations may be more general and/or specific to a programming language (e.g., Erlang, Elixir, programming languages on top of the BEAM, bytecode, OCaml, Perl, Swift, PHP, Python, BASIC, Kotlin, Go, Golang, JavaScript, Objective-C, Ruby, Flutter® (Flutter® is a registered trademark of Google Inc, of Mountainview, Calif.) React Native® (React Native ° is a registered trademark of Meta Platforms Inc, of Menlo Park, Calif.), C, C#, C++, Java, or other capable programming languages, etc.).

The processor 402 may be operatively coupled to a communication interface 406 such that the server system 400 can communicate with a remote device such as the computing devices 20, 22, 24, and/or 26, the message server 14, a client system 300, or another server system. For example, the communication interface 406 may receive communications from the user computing devices 20, 22, 24, and/or 26 and the message server 14.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is like a transaction database. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and/or non-volatile RAM (NVRAM). The above memory types are exemplary only and are thus not limiting as to the types of memory usable for storage of a computer program.

In some embodiments, it is contemplated that the server system 400 may be implemented as a software application. In such embodiments, the hardware described above, such as the processor 402, the memory area 404, the communication interface 406, and/or the storage interface 408 may be shared with the hardware components of the message server 14, such as the processor 202, the memory device 204, and/or the transceiver 210.

### Exemplary Table Records

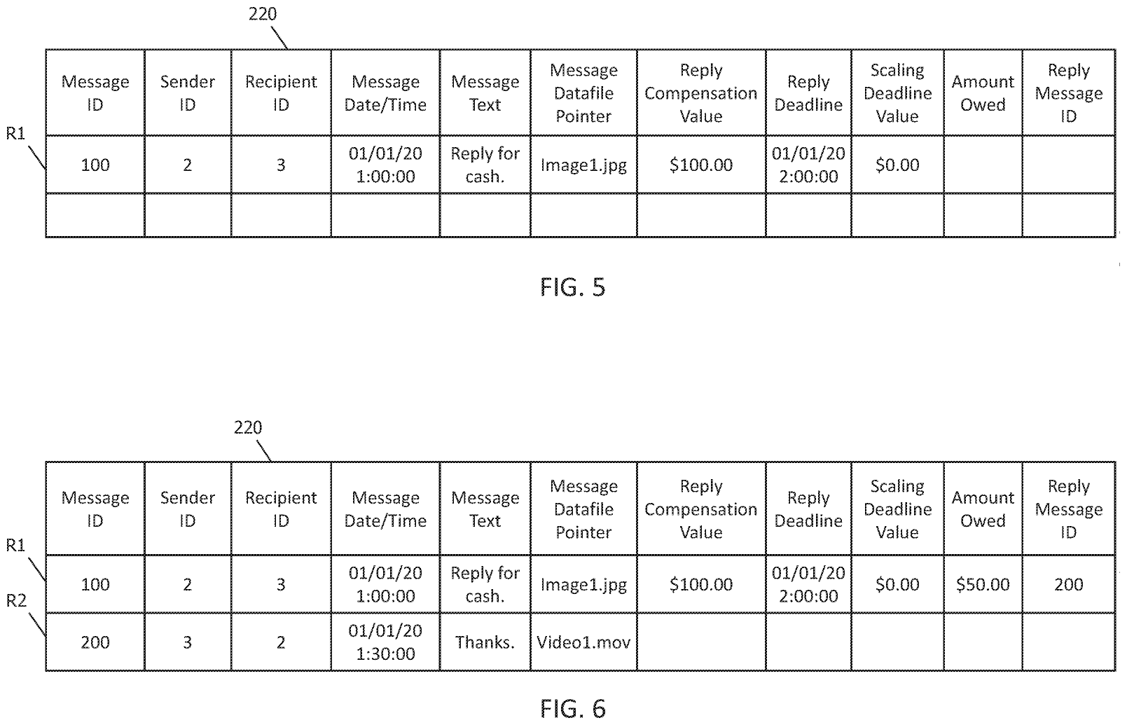

FIG. 5 is an example schematic illustration of a message table 220 including compensation message record R₁. As described above, a user, such as user 28 (the “sender”), submits an electronic compensation message, to one or more users (the “recipients”) to receive a compensation message that may include, not withstanding, sender name, reply compensation value, reply deadline and/or message data (e.g., text, emojis, images, and/or datafiles). The message table 220 may include a plurality of data fields (e.g., columns of the table 220), including, for example, and without limitation, at least a field for unique message identification, message sender identification, message receiver contact information, message time, message text content, message datafile identifier, message reply compensation value, message reply deadline, and message reply compensation calculation function. The database field titles shown in FIG. 5 and FIG. 6 are example field titles only. As described above, the data fields of message records (e.g., columns of the table) may be stored in one or more tables, span two or more tables, and/or included as part of one or more database tables and/or database systems, and the like. For example, in one embodiment, the data fields may be split into two or more tables. Additionally in another embodiment, all of the content discussed herein may be included as part of an existing message record, and/or message system, thus including some and/or all of the processes associated with this system into an existing message record, messaging system, database system, and/or communication system.

In the exemplary embodiment, the compensation message record R₁ may be allocated a Message ID of 100 by the message module 214 (shown in FIG. 2). The Message ID is used to uniquely identify the message, such as to identify to which message a reply message is associated. For example, in one example embodiment, each message transmitted by the message server 14 (shown in FIG. 2) may include, for example, a header including various metadata. The metadata may include, for example, the message ID, and if the message is a reply message, the message ID of the message to which the reply message is associated. As such, the message module 214 may match messages to one another based on the metadata contained in the message header.

The compensation message record R₁ may include a Sender ID associated with the sender of the message. The Sender ID may be mapped to the User ID of the user generating the message. The User ID may be assigned to a user during registration with the messaging service system 12 (shown in FIG. 1) and may be stored in the user table 222 (shown in FIG. 2). In one example, each user may log into the message server 14 before generating and/or receiving messages, and as such, the message server 14 (and in turn, the message module 214) may associates each message with the user's User ID.

The compensation message record R₁ may include one or more Recipient IDs. The Recipient ID may be associated with the User ID of users that the sender wishes to transmit the compensation message to. In some embodiments, the user sending the message may select one or more users (i.e., recipients) from a list of users presented via the messaging application displayed by the user interface 34 on the user's (i.e., sender's) computing device 20, 22, 24, or 26. The message module 214 may enter the selected Recipient IDs into the compensation message record R₁.

In the exemplary embodiment, the date and time that the message is generated or recorded is entered into the Massage Date/Time data field. The Message Text and Message Datafile Pointer data fields include the plain text and/or pointers to datafiles, respectively, to be included in the message transmitted to the one or more Recipient IDs.

Furthermore, as described above, when a user records a compensation message, the user may input reply compensation value, reply deadline, and optionally, message text content, message image content, and/or reply compensation calculation function. The compensation message record R₁ includes the Reply Compensation Value data field for the reply compensation value entered by the user, the Reply Deadline field for holding the date and time entered by the user, and the Scaling Deadline Value field for holding the reply compensation calculation function. As used herein, a scaled reply compensation value or “scaling” of the reply compensation value includes applying a function to the total compensation amount owed based, in part, on reply message time relative to reply deadline.

In the exemplary embodiment, the data fields Scaling Amount Owed and Reply Message ID may be blank and/or null when and if the compensation message record R₁ is recorded by the user. These fields may be updated by the message module 214 when and if a reply message is received from one or more of the message recipients.

FIG. 6 is an example schematic illustration of a message table 220 including the compensation message record R₁ and a reply message record R₂. The reply message record R₂ is automatically generated by the message module 214 when a reply message is detected. In the exemplary embodiment, the reply message record R₂ corresponds to a message transmitted by a recipient of the compensation message record R₁ (e.g., User ID 3) in reply thereto.

In the exemplary embodiment, the reply message record R₂ is allocated a Message ID of 200 by the message module 214 (shown in FIG. 2). The Message ID is used to identify the message to which a reply message is associated. In one example embodiment, a header of the reply message may include, for example, the message ID and the message ID of the message to which the reply message is associated. This enables the message module 214 to match the reply message to the compensation message record R₁.

In the exemplary embodiment, the reply message record R₂ may include a Sender ID associated with the sender of the message. As described above, the Sender ID is mapped to the User ID of the user generating the message. In addition, for a reply message, the reply message record R₂ includes the recipient ID, which is equal to the one or more recipients designated in the reply message. For example, the message may be in reply to a single sender or part of a group message. As such, the Recipient ID data field is filled with the User IDs of each recipient of the reply message.

In the exemplary embodiment, the reply message record R₂ may include the date and time that the message is generated, which is entered into the Massage Date/Time data field. The Message Text and Message Datafile Pointer data fields may include plain text and/or pointers to datafiles, respectively, that were included in the reply message.

In the exemplary embodiment, the compensation message record R₁ may be updated to include a function for calculating total compensation amount owed including a regressive scaling function Scaling Amount Owed data field, which is determined by the message server 14, as described further herein. The Reply Message ID field may be updated to include the unique Message ID assigned to the reply message by the message module 214.

### Exemplary Computer-Implemented Methods

The operations for the computer implemented methods described herein may be performed in the order shown in the respective figures, or according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer implemented methods are described below, for ease of reference, as being executed by exemplary devices and components introduced with the embodiments illustrated in FIGS. 1-6. In one embodiment, the message server 14 (shown in FIG. 2) implements the computer implemented methods. In the exemplary embodiment, the computer implemented methods relate to tracking message interactions and providing compensation for responding to certain messages. While operations within the computer-implemented methods are described below regarding the message server 14, according to some aspects of the present invention, the computer implemented methods may be implemented using any other computing devices and/or systems through the utilization of processors, computer, server, virtual computer, virtual server, machine, virtual machine, computer system, server system, virtual server system, virtual computer system, virtual network, transceivers, hardware, software, firmware, network, and/or combinations thereof. A person having task appropriate skill will also appreciate that responsibility for all or some of such actions may be distributed differently among such devices or other computing devices without departing from the spirit of the present disclosure.

One or more computer readable medium(s) may also be provided. The computer readable medium(s) may include one or more executable programs stored thereon, wherein the program(s) instruct one or more processors or processing units to perform all or certain of the steps outlined herein. The program(s) stored on the systems's computer readable medium(s) may instruct the processor or processing units to perform additional, fewer, or alternative actions, including those discussed elsewhere herein.

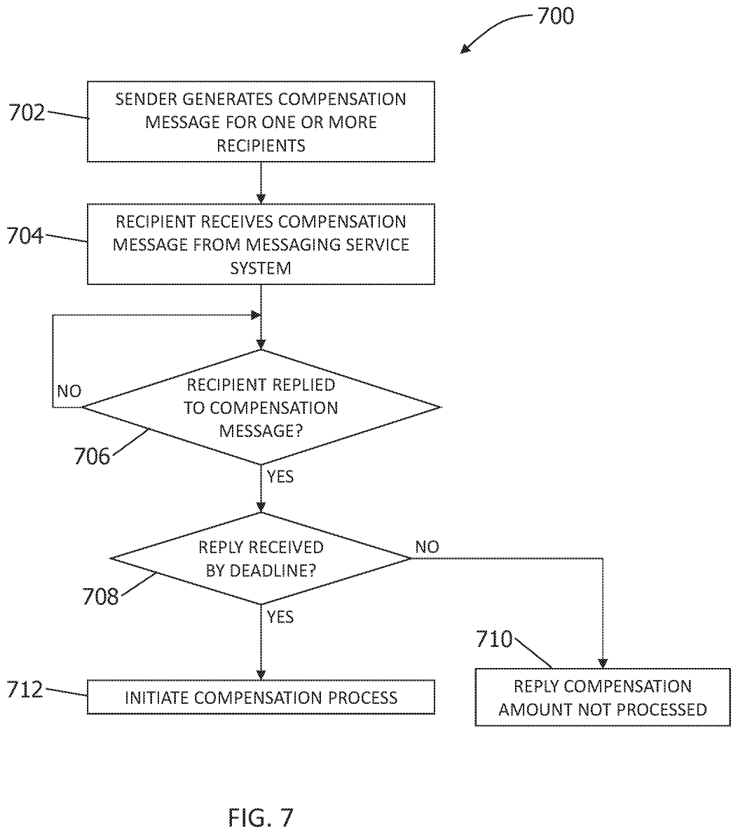

FIG. 7 is an example of a flowchart illustrating an exemplary computer-implemented method 700 for determining a total compensation amount owed to a message recipient for replying to a compensation message, in accordance with one embodiment of the present disclosure. At operation 702, in the example embodiment, the message sender (e.g., the user 28 (shown in FIG. 1)) generates a compensation message for one or more recipients (e.g., the user 30 (shown in FIG. 1)). In particular, the message server 14 may receive from the message sender input data associated with a compensation message the sender wishes to send to one or more recipients via the message server 14 and generates the compensation message. The input data of the compensation message provided by the message sender may include, for example, and without limitation, reply compensation value, reply deadline, and recipient, and may additionally include message content (e.g., text, emojis, and/or datafiles). The message module 214 (shown in FIG. 2) monitors input data received by the message server 14. When the message module 214 identifies a compensation message request input, it writes a compensation message record, such as the compensation message record R₁ (shown in FIG. 5), to the message table 220 (shown in FIG. 2). One or more service fee may be subtracted from the amount owed to the message recipient at any point in the system process and/or after the system process. The message sender and/or message recipient acceptance of the total compensation amount owed and/or any payment satisfies all and/or part of conditional requirements of the compensation message may be included at any point in the system process and/or outside the system process, including but not withstanding after total compensation amount owed is calculated. The message sender and/or message recipient may rate the corresponding message sender and/or message recipient, and/or the message sender and/or message recipient may rate the content and/or the quality of the interaction with the message sender and/or message recipient, and any of the ratings mentioned herein may be included at any point during the system process and/or outside the system process. Message sender may also include people, machines, systems of chance and/or any other entity within and/or outside of any part of the system. As described herein, in one example, the compensation message record functions as the compensation message. As part of another embodiment, for example, a transaction cancellation process may be initiated by the message sender and/or message recipient. And part of another embodiment, the compensation message may be generated and/or initiated by any person, message recipient user, any system, any network, any machine, any computer, any virtual system, any automated machine, and/or any entity in and/or outside of the system that is able to initiate an action that allows the process to be activated.

More particularly, upon receipt of a compensation message request by a user, such as the user 28 (the “sender”), the message server 14 may collect various information from sender, database 16, and/or the messaging service system 12 (shown in FIG. 1). For example, the message server 14 collects a message ID (e.g., allocated by the message server 14), sender ID, recipient ID(s), message date/time (e.g., from an internal clock of the message server 14), message text and/or message datafile pointer, reply compensation value, and reply deadline, and optionally, a scaling deadline value. In one embodiment, the sender ID and recipient ID(s) may be obtained, for example, from the user table 222 by matching the sender (e.g., user 28) and recipients to the associated user records, such as user records UR₁, UR₂, and UR₃ (shown in FIG. 2).

At operation 704, the recipient receives the compensation message from the messaging service system 12, and more particularly, from the message server 14. In one suitable embodiment, the message server 14 transmits an audible and/or visual message notification or alert to the recipient, for example, via the messaging application installed on the user computing device 20, 22, 24, or 26, via email, SMS message, and the like. The notification or alert may include, for example, a graphical display change, icon change, icon flash, audible tone, tone sequence, etc. In the exemplary embodiment, the recipient may be presented with the sender information (e.g., name, etc.), the reply compensation value, and the reply deadline. The recipient may select to open the compensation message, for example, within the messaging application, to view the message content and to, optionally, reply to the compensation message. In one example, opening the compensation message includes reading the information or data contain in the compensation message record.

At operation 706, the message server system 14 determines whether the message recipient has replied to the compensation message, and at operation 708, determines whether the reply message is received by the deadline specified by the sender of the compensation message. In particular, if the recipient replies to the compensation message, the message module 214 identifies the incoming reply message (e.g., a reply message request) and writes a reply message record R₂ to the message table 220. For example, the message server 14 collects a message ID (e.g., allocated by the message server 14), sender ID, recipient ID, message date/time (e.g., from an internal clock of the message server 14), message text and/or message datafile pointer, and optionally, a reply compensation value and reply deadline. If a reply compensation value and reply deadline are collected, the message server 14 may optionally collect a scaling deadline value from the recipient as well. In one embodiment, the sender ID and recipient ID may be obtained, for example, from the user table 222 by matching the reply sender (e.g., user 30) and recipient to the associated user records, such as user records UR₁, UR₂, and UR₃ (shown in FIG. 2).

In one example embodiment, the message module 214 searches the message table 220 to identify instances (e.g., message exchanges) where the reply message record R₂ has a message date/time that is equal to or less than the Reply Deadline of a previous message record (e.g., the compensation message record R₁), the Sender ID of the reply message record R₂ includes a Recipient ID of the previous message record, the Recipient ID of the reply message record R₂ includes the Sender ID of the previous message record, and the reply message compensation has not been satisfied (e.g., the Reply Message ID data field is NULL). In such instances, the messages (i.e., the reply message record R₂ and the identified previous message record matching the criteria) are associated as compensation message/replay message.

If the Message Date/Time data field of the reply message record R₂ is less than or equal to the Reply Deadline data field of the previous message record, such as the compensation message record R₁, the message module 214 updates the Reply Message ID data field of the compensation message record R₁ with the Message ID of the reply message record R₂, and the method 700 continues to operation 712. However, if the Message Date/Time data field of the reply message record R₂ is greater than the Reply Deadline data field of the compensation message record R₁, the method 700 ceases to process a compensation amount at operation 710, and no compensation is owed to the recipient.

At operation 712, the message server 14 may initiate the compensation process and determine the total compensation amount owed to the message recipient. In particular, the compensation determination module 218 (shown in FIG. 2) of the message server 14 calculates a total compensation amount that is due to be paid to message recipient by the message sender based on the example entry in the Reply Compensation Value data field of the compensation message record R₁. In some embodiments, the total compensation value is determined by the Reply Compensation Value data field of the compensation message record R₁ and the reply message date/time relative to the deadline provided by the sender. And as part of any embodiment, and without limitation, time used to calculate anything of value to the message recipient, including without limitation, calculating total compensation amount owed to message recipient, may use time the reply message is received by message sender, time reply message is sent by message recipient, time reply message is saved to system database and/or any time associated with the time the recipient responds to the compensation message. In any embodiment, time may include a calendar date, day, hour, second, any fraction thereof, and/or any method based on a system of time, including a stop watch, rotation of solar bodies, time calculation based on any consistent action of an entity and/or a time countdown.

In certain embodiments, after a total compensation amount owed is calculated, the message server system 14, and/or the compensation determination module 218, may transmit payment transaction data to the payment processor 32 (shown in FIG. 1), including, for example, a payment sender identification, payment receiver identification, token information, any data necessary to initiate the payment process and/or total compensation amount owed, total compensation amount owed minus one or more fees and/or any data necessary to initiate compensation to the benefit of message recipient and/or from the compensation message sender. The transaction includes, for example, payment account data of the sender and/or the recipient, and a total compensation value with or without fees subtracted, to be paid to the benefit of message recipient and/or payment by and/or from message sender.

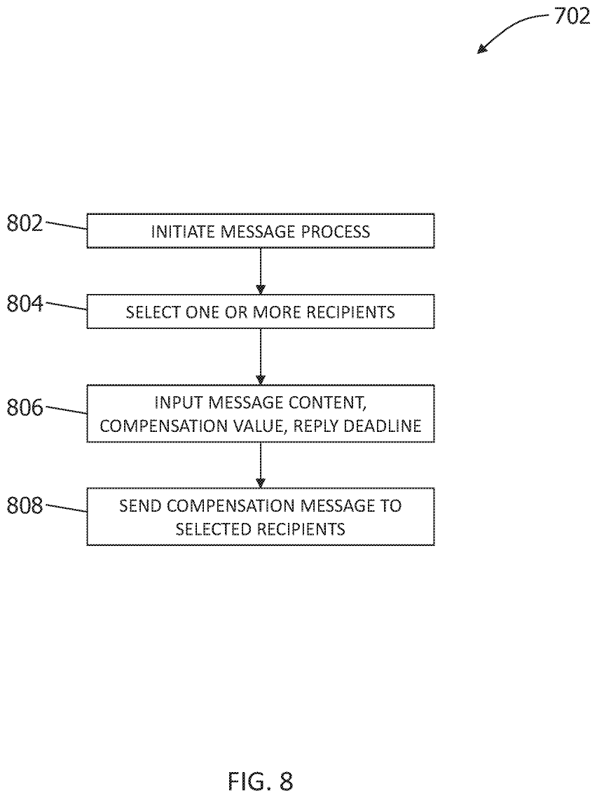

FIG. 8 is a flowchart illustrating the operations of step 702 of the method 700, described above. At operation 802, the sender initiates, via the messaging application for example, a messaging process for generating, for example, a new compensation message for one or more recipients (e.g., the user 30 (shown in FIG. 1)). In one embodiment, the sender logs into his or her messaging account with the messaging service system 12 using, for example, the messaging application installed on the user computing device 20, 22, 24, or 26.

At operation 804, the sender selects one or more recipients to receive the compensation message, or in some embodiments, replies to one or more users. In the exemplary embodiment, the sender selects recipients from a list of active users of the messaging service system 12. Alternatively, or additionally, the sender may add one or more recipients that are not active users. For example, and without limitation, the sender may input a telephone number that can receive SMS messages, an email address, or other electronic communication method, for the additional recipients that are to receive the compensation message.

At operation 806, the sender inputs the compensation message content, such as a text message, an emoji, and/or a datafile. In addition, the sender inputs the reply compensation value and the reply deadline. In certain embodiments, the sender may include additional details such as a scaling deadline value indicating that the reply compensation value is scaled, for example, with time.

In particular, the message server 14 collects various information from the sender, the database 16, and/or the messaging service system 12 (shown in FIG. 1). For example, the message server 14 collects a message ID (e.g., allocated by the message server 14), sender ID, recipient ID(s), message date/time (e.g., from an internal clock of the message server 14), message text and/or message datafile pointer, reply compensation value, and reply deadline, and optionally, a scaling deadline value. In one embodiment, the sender ID and recipient ID(s) may be obtained, for example, from the user table 222 by matching the sender (e.g., user 28) and recipients to the associated user records, such as user records UR₁, UR₂, and UR₃ (shown in FIG. 2). At operation 810, the sender transmits the compensation replay message to the one or more recipients, for example, by pressing a “SEND” option within the messaging application.

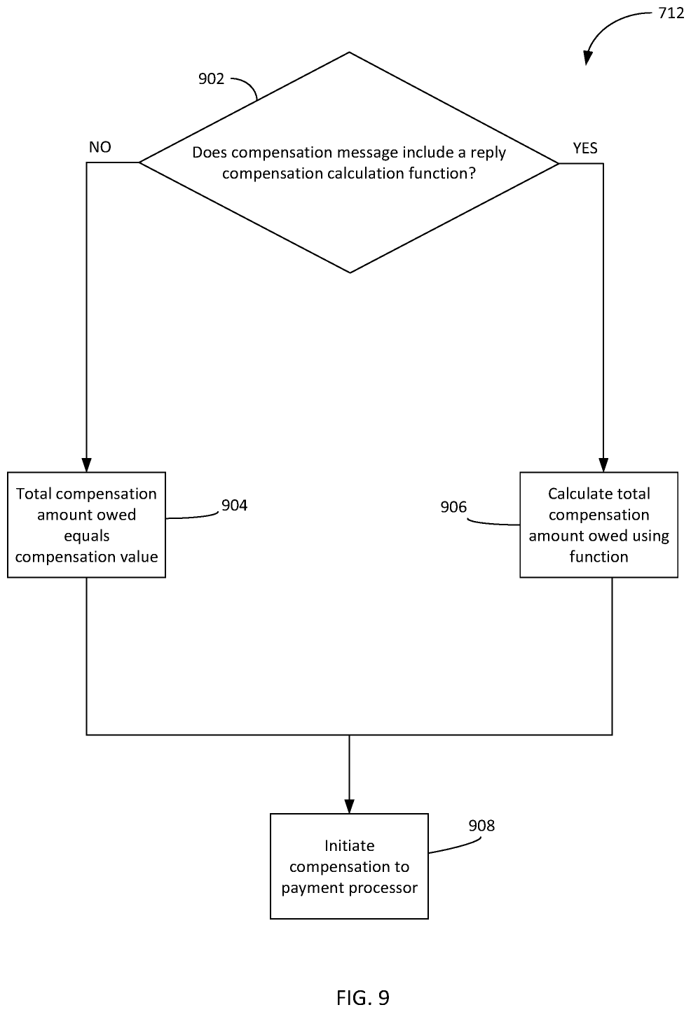

FIG. 9 is a flowchart illustrating example operations of step 712 of the method 700, described above. To determine the total compensation amount owed to a recipient, at operation 902, the compensation determination module 218 determines whether the compensation message record R₁ has an associated message reply compensation calculation function. Total compensation amount owed is calculated and the method continues at operation 906. If the compensation message does not have an associated message reply compensation calculation function, at operation 904, the method determines that the total reply compensation value is not changed, and as such, the total compensation amount owed to the recipient is the value of the compensation value, minus any service fees. In one example embodiment, the message reply compensation calculation function includes a regression line and/or a algorithmic calculation based on reply criteria, including, and without limitation, scaling calculations, dependency on the time of the reply, and/or the satisfaction of the reply content by the reply recipient which may include an image, and/or text, and may include an approval request of satisfactorily completing the sender's request, and may include the message sender rating the message recipient, the message sender rating the quality of the reply message, and/or the recipient rating the message sender.

In the example, if the compensation message includes an associated reply compensation calculation function, at operation 906, the compensation determination module 218 calculates the total compensation amount owed to the recipient using the conditions of the reply compensation calculation function. For example a diminishing value function. In the exemplary embodiment, the diminishing value function is a linear regression function. In an example illustrated in FIGS. 5 and 6, the compensation message record R₁ includes a reply compensation value of $100 (“CVR₁”) and a scaling deadline value of $0.00 (“DVR₁”). In addition, the compensation message record R₁ includes a message date and time of 01/01/20, 1:00:00 (“MDR₁”) and a reply deadline of 01/01/20, 2:00:00 (“RDR₁”). The reply message record R₂ includes a message date and time of 01/01/20, 1:30:00 (“MDR₂”). One example formula for determining the reply compensation amount owed is:

$${CVR}_{1} + ( \frac{( {DVR}_{1} - {CVR}_{1} )}{( {RDR}_{1} - {MDR}_{1} )} \times ( {MDR}_{2} - {MDR}_{1} ) ) = scaling amount owed$$

Plugging in the values gives the following:

$$\$ 100 + ( \frac{( \$ 0.00 - \$ 100 )}{( 2 : 00 - 1 : 00 )} \times ( 1 : 30 - 1 : 00 ) ) = \$50 = scaling amount owed$$

Thus, in the example linear regression formula and for the values given above, a recipient that replies thirty (30) minutes after the compensation message time, which has a reply period of sixty (60) minutes, will receive a total compensation amount owed of $50. It is noted that the above described formula is just an example and that many different functions can be used to determine the total compensation amount owed, minus any service fees.

In one example embodiment, the compensation determination module 218 updates the total compensation amount owed for the compensation message record R₁ with the calculated, scaled total compensation value determined above.

At operation 908, the message server 14 initiates the compensation to the recipient. For example, in one suitable embodiment, the compensation determination module 218, transmits payment transaction data to the payment processor 32 (shown in FIG. 1). The transaction includes, for example, payment authorization data of the sender and/or the recipient, and the total compensation amount owed, to be paid by the sender to the recipient, minus any service fees.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A method, comprising: using machine readable instructions to: (a) receive a receiving message; (b) identify in a system database a compensation message that: (i) has a reply compensation deadline time that is greater than or equal to a receiving message time; and (ii) a recipient of said receiving message is the same as a sender of said compensation message; (c) adjust a compensation amount based on a difference between said reply compensation deadline time and said receiving message time; and (d) trigger a compensation to a recipient of said compensation message.

2. A method, comprising: using machine readable instructions to: (a) receive a receiving message; and (b) identify in a system database a compensation message that: (i) has a reply compensation deadline time that is greater than or equal to a receiving message time; and (ii) a recipient of said receiving message is the same as a sender of said compensation message.

3. The method of claim 2, further comprising initiating a compensation if no compensation has previously been made in association with said compensation message between said recipient of said receiving message and a recipient of said compensation message.

4. The method of claim 3, wherein said recipient of said receiving message and said recipient of said compensation message are different.

5. The method of claim 2, further comprising evaluating each of said recipient of said receiving message, a recipient of said compensation message, said compensation deadline time, and an amount of compensation.

6. The method of claim 3, wherein said compensation is adjusted based on a difference between said reply compensation deadline time and said receiving message time.

7. The method of claim 4, wherein said compensation is adjusted based on a difference between said reply compensation deadline time and said receiving message time.

8. The method of claim 2, further comprising creating a message record, said message record comprising a field for each of a compensation history associated with said compensation message, a message identifier, a message content, a deadline, a deadline amount value, a file name, a compensation adjustment function, and a payment satisfaction indicator.

9. The method of claim 2, further comprising creating a message record comprising a deadline amount value.

10. The method of claim 2, further comprising creating a message record comprising a deadline.

11. The method of claim 2, further comprising creating a message record comprising a payment indicator indicating a payment between said recipient of said receiving message and a recipient of said compensation message.

12. The method of claim 2, further comprising creating a message record comprising a payment indicator indicating a payment between said recipient of said receiving message and a recipient of said compensation message based on an adjustable payment function.

13. The method of claim 2, wherein said receiving message time is associated with a time said receiving message is received at a computer.

14. The method of claim 2, wherein said receiving message time is associated with a time said receiving message is received at a computer and saved in a database.

15. The method of claim 2, wherein said receiving message time is a time said receiving message is sent by a recipient of said compensation message.

16. A method, comprising: using machine readable instructions to receive messages each having a reply deadline and a deadline amount value.
